(19) United States
(12) Patent Application Publication
(10) Pub. No.: US 2024/0083562 A1
(43) Pub. Date: Mar. 14, 2024

(54) WATERCRAFT AND METHOD FOR OPERATING A WATERCRAFT

(71) Applicant: Siemens Energy Global GmbH & Co. KG, Munich, Bayern (DE)

(72) Inventors: Michael Frank, Uttenreuth (DE); Jörn Grundmann, Grossenseebach, Bayern (DE); Peter van Hasselt, Erlangen (DE)

(73) Assignee: Siemens Energy Global GmbH & Co. KG, Munich, Bayern (DE)

(21) Appl. No.: 17/767,882

(22) PCT Filed: Sep. 29, 2020
(86) PCT No.: PCT/EP2020/077187

§ 371 Date: Apr. 9, 2022

(30) Foreign Application Priority Data
Oct. 21, 2019 (DE) 10 2019 216 155.3

(51) Int. Cl. B63G 7/06; B63H 21/17

(52) U.S. Cl. CPC B63G 7/06; B63H 21/17; B63G 2007/005; B63G 2007/065

(57) ABSTRACT

A watercraft includes at least one high-temperature superconducting coil and a cooling system for cooling the high-temperature superconducting coil to a cryogenic operating temperature, wherein the cooling system has a first cryostat tank, which surrounds the high-temperature superconducting coil and is designed to hold a liquid phase of a cryogenic coolant; wherein the watercraft also has a load, which is designed to convert an operating medium in the form of a fuel and/or in the form of a material promoting combustion; wherein at least one first material component of the operating medium is formed by the cryogenic coolant; and wherein the first cryostat tank is designed to hold a major part of the required total amount of the first material component of the operating medium for the operation of the load. A method operates a watercraft of this type.

### CROSS REFERENCE TO RELATED APPLICATIONS

This application is the US National Stage of International Application No. PCT/EP2020/077187 filed 29 Sep. 2020, and claims the benefit thereof. The International Application claims the benefit of German Application No. DE 10 2019 216 155.3 filed 21 Oct. 2019. All of the applications are incorporated by reference herein in their entirety.

### FIELD OF INVENTION

The present invention relates to a watercraft having at least one high-temperature superconducting coil and having a cooling system for cooling the high-temperature superconducting coil to a cryogenic operating temperature. Furthermore, the invention relates to a method for operating a watercraft of this kind.

### BACKGROUND OF INVENTION

The prior art discloses watercraft which have one or more superconducting coils, either as part of the propulsion system or else as separate magnet coils. Thus, EP 1636894B1, for example, describes a motor device having a superconducting rotor winding, which, owing to the robust design of its cooling system, is particularly suitable for use in propulsion systems of ships. Furthermore, EP 34 05 387 A1 describes a drone for triggering sea mines, in which a superconducting excitation coil not only acts as part of the electric drive motor but also forms the external magnetic field which brings about the triggering of the sea mines.

A general difficulty in watercraft having superconducting coils is that of reliably effecting cooling of the superconducting coil to a cryogenic operating temperature. This is all the more difficult, the more compact the system is, and therefore the less space is available overall for the superconducting coil and the associated cooling system. This represents an unresolved problem, especially in the case of relatively small and, in particular, unmanned watercraft since the installation space here is particularly limited.

### SUMMARY OF INVENTION

It is therefore the object of the invention to specify a watercraft which overcomes the disadvantages mentioned. In particular, the intention is to provide a watercraft in which the cooling system of the superconducting coil requires as little additional space as possible. A further object is to specify a method for operating a watercraft of this type.

These objects are achieved by the watercraft and the method for operating a watercraft as described in the independent claims. The watercraft according to the invention has at least one high-temperature superconducting coil and a cooling system for cooling the high-temperature superconducting coil to a cryogenic operating temperature. This cooling system has a first cryostat tank, which surrounds the high-temperature superconducting coil and is designed to hold a liquid phase of a cryogenic coolant. The watercraft additionally has a load for converting an operating medium, wherein the operating medium is a fuel and/or a combustion-promoting substance or comprises such a substance. In this case, at least one first substance component of the operating medium is formed by the cryogenic coolant. The first cryostat tank is designed to hold a majority of the total quantity of the first substance component of the operating medium required for the operation of the load.

In this context, a watercraft should generally be understood to mean a vehicle which is designed to move in water. In general, this may in principle be either a manned or an unmanned watercraft—in the second case, therefore, a drone. Furthermore, the watercraft can be designed for movement on the surface of the water and/or below the surface of the water.

The cryostat tank described is intended to surround the at least one high-temperature superconducting coil. In particular, it is possible for a plurality of such coils to be arranged within the cryostat tank. In general, it is also possible for there to be a plurality of cryostat tanks, in each of which either one or more such coils are then arranged. The essential point is that the respective coil is surrounded by the associated cryostat tank in such a way that it is thermally insulated by it from a warm external environment. The cryostat tank is designed to hold a liquid phase of a cryogenic coolant, and it can therefore be, in particular, a bath cryostat. In this case, however, it should not be excluded that the cryogenic coolant is also present at least partially in the gas phase within the cryostat tank. In particular, therefore, there can be an equilibrium within the cryostat tank between the liquid phase and the gas phase of the cryogenic coolant during the operation of the watercraft and thus during the cooling of the high-temperature superconducting coil. As an option, the cryogenic coolant can in this case also be part of the described cooling system and thus also part of the watercraft. However, this is not absolutely necessary. It is particularly important that the cooling system is designed for cooling the coil with such a cryogenic coolant.

The operating medium for the load should comprise a fuel and/or a combustion-promoting substance. In particular, the operating medium can be a mixture of at least two such substance components. In general, a mixture of a fuel and oxygen or air is particularly advantageous in this context. A first substance component of this operating medium (that is to say, in particular, either a fuel or a combustion-promoting substance) should be formed by the cryogenic coolant. It is particularly advantageous if the cryogenic coolant forms the fuel itself or at least one substance component of the fuel. In general and independently of the exact composition, the first substance component of the operating medium can advantageously be formed by the gaseous phase of the coolant, which is formed by evaporation from the liquid coolant used for cooling the superconducting coil.

The “total quantity required for the operation of the load” of the first substance component of the operating medium is to be understood here as meaning, in particular, the total quantity of this substance component which is carried on the watercraft during the operation of the latter. The watercraft is thus designed to carry this total quantity, the total quantity corresponding to the total stored volume of this first substance component in the fully fueled state. This stored volume includes, in particular, the filling volume of the cryostat tank and the volume of an optionally present supply line, which is arranged between the cryostat tank and the load. In particular, a coolant discharge line of the cryostat tank can open into such an operating medium supply line and/or can merge into it and/or be connected to it. The only essential point is that the load can be fed with the cryogenic coolant present in the cryostat tank. It should be possible here for a majority of the above-described total quantity of the first substance component of the operating medium (and thus at the same time the total quantity of the cryogenic coolant) to be held by the first cryostat tank. In other words, the filling volume of the first cryostat tank should be able to hold more than 50% by volume of this total quantity of cryogenic coolant. In other words, all other storage volumes available for the cryogenic coolant (that is to say, in particular, the total volume of all the additional lines and optionally available additional reservoirs outside the cryostat tank) should be smaller than the filling volume of the cryostat tank for the cryogenic coolant.

The latter feature enables the required installation space for the high-temperature superconducting coil and its cooling system, as well as for the required supply of operating medium, to be kept very small overall. This is achieved, in particular, by virtue of the fact that a predominant proportion of the liquid cryogenic coolant is used twice, namely, on the one hand, for cooling the coil within the cryostat tank and, on the other hand, as an operating medium for the load. This double utilization of the coolant leads above all to a particularly small overall space requirement if—as described—it is primarily the cryostat tank itself which serves as a storage tank for the coolant, and only a subordinate additional volume contributes to the stored volume of the coolant. The cryogenic coolant is therefore to be stored predominantly in the cryostat tank during operation, and only a comparatively small proportion is to be stored in the lines or other additional operating medium chambers. In particular, the watercraft is therefore not intended to have an additional storage tank for the cryogenic coolant which is larger than the filling volume of the cryostat tank. In this context, the filling volume of the cryostat tank should be understood to mean the volume of cryogenic coolant which can be introduced into the cryostat tank (in addition to the coil already present therein).

This design makes it possible to ensure that the fluid volume present in the cryostat tank is simultaneously used as a storage volume for the first substance component of the operating medium, and that the space for an additional storage tank, which would otherwise be required, for this substance component can thus be saved. This allows a particularly space-saving embodiment of the overall system.

The method according to the invention is used for operating a watercraft according to the invention. In this context, the liquid phase of the cryogenic coolant in the first cryostat tank is used for cooling the at least one high-temperature superconducting coil. In this case, the same cryogenic coolant is used as the substance component of the operating medium which is converted by means of the load. The advantages of the method according to the invention are obtained here in a manner similar to the advantages already described for the watercraft according to the invention.

Advantageous embodiments and developments of the invention can be found in the dependent claims and in the following description. Here, the described embodiments of the watercraft and of the operating method can in general advantageously be combined with one another.

Thus, the first cryostat tank can in general advantageously be designed to hold a proportion of at least 75%, and in particular even at least 90%, of the total quantity of the first substance component of the operating medium required for the operation of the load. In other words, the cryostat tank should therefore be able to hold an even more preponderant portion of the total supply quantity of this substance component. Thus, only a comparatively insignificant portion of the total quantity of this substance component is to be stored in other volumes, which lie outside the cryostat tank. This results in an even greater reduction in the overall installation space required in comparison with a conventional separate storage tank for the operating medium.

The cryogenic coolant may, in general, advantageously be, for example, hydrogen, methane, natural gas or oxygen or comprise at least one of these substances. In this case, hydrogen, methane and natural gas are particularly preferred examples of the fact that the cryogenic coolant is a fuel. Oxygen, on the other hand, is a particularly preferred example of a combustion-promoting substance.

In general, it is particularly advantageous within the scope of the present invention if the cryogenic coolant forms a fuel for the load. Thus, the operating medium can then have a fuel as the first substance component and a combustion-promoting substance as the second substance component. The first cryostat tank is then in turn preferably designed to hold this first substance component. It is the particularly advantageous if the cooling system has a second cryostat tank, which encloses the first cryostat tank in the form of a jacket and is designed to hold the second substance component. This second substance component of the operating medium can in turn be provided, for example, by oxygen, air or else by some other combustion-promoting substance. The described nesting of the first and second cryostat tanks ensures that the internal high-temperature superconducting coil can be cooled particularly effectively since the second cryostat tank is arranged as additional thermal insulation around the first cryostat tank. This is particularly advantageous if the second substance component also forms a cryogenic coolant in its liquefied form. This is particularly the case with liquid oxygen. Particularly in the case of an underwater vehicle, the oxygen required for the combustion of the fuel cannot be supplied from the ambient air but must be carried in a storage tank in the watercraft. In the described advantageous embodiment with a second, outer cryostat tank, the space for an additional storage tank can again be largely saved, and therefore the oxygen also has a dual use, namely, on the one hand, as a cryogenic coolant and, on the other hand, as a combustion-promoting substance. The storage of the oxygen in the outer cryostat tank leads, in a manner similar to the advantages of the first cryostat tank described above, to a particularly space-saving implementation of the overall system.

In general, it is particularly advantageous if the load is designed to be operated with a gaseous phase of the coolant. In other words, the first substance component of the operating medium should only be employed in liquid form when it is being used as a cryogenic coolant. During the cooling of the superconducting coil, some of this liquid coolant evaporates, and the gaseous coolant formed therefrom can be fed via a gas line, as part of the operating medium, to the load operated therewith. Here, supply to the load in the gas phase is significantly less complex in terms of apparatus than would be supply in liquefied form. Moreover, supply in liquefied form is typically not necessary if the coolant continues to be used as the operating medium of the load.

It is particularly advantageous in the described embodiment if the watercraft has a gas outlet line as part of the cooling system. As a particular preference, this gas outlet line can be arranged at least partially within the first cryostat tank and can be thermally coupled there, at least in a partial region, to a part of the superconducting coil in such a way that cooling of the coil can be effected by the gaseous coolant flowing in the gas outlet line. The advantages of this embodiment come to bear particularly when a significant portion of the liquid coolant has already evaporated in an operating state of the watercraft and has thus been consumed for cooling. In such an operating state, it may happen that the high-temperature superconducting coil is no longer completely submerged in the liquid coolant and is then only surrounded by gaseous coolant, at least in partial regions. However, the coil can be cooled nowhere nearly as effectively by contact with gaseous coolant as by contact with liquid coolant. In particular, without special measures, the gaseous coolant in the direct vicinity of the coil might heat up to such an extent that an operating temperature below the transition temperature of the superconductor can no longer be reliably ensured. In order to prevent this, in a particularly advantageous embodiment, that part of the evaporated coolant which is removed as operating medium is selectively made to flow past the coil again before its further use. This prevents local heating of the gas phase surrounding the coil and permits more effective cooling of the coil by the gaseous coolant removed.

As an alternative to the described embodiment with thermal coupling of the superconducting coil to a part of the gas outlet line, selective flow around upper regions of the coil can also be achieved by forming a bottle neck in the region of a part of the coil which (typically) lies geodetically at the top. In other words, the selected cross section of the cryostat tank filling volume surrounding the coil in the manner of a jacket can be smaller in such an upper part of the coil than lower down. This too advantageously leads to a greater gas flow in the immediate vicinity of the coil parts which are no longer submerged in the liquefied coolant in an advanced operating stage.

Irrespective of the precise implementation, the described measures advantageously ensure that the superconducting coil does not have to be completely submerged in the liquid coolant during the entire operation of the watercraft. On the contrary, reliable cooling can be ensured even if only part of the superconducting coil is in thermal contact with the liquid coolant. The thermal conductivity of the superconducting coil itself (and of optional additional thermally conductive elements which are in contact with it) can also allow sufficiently high heat dissipation from the regions of the coil which are no longer submerged in the liquid coolant.

In general and irrespective of the exact embodiment, the coil can either be in direct or indirect contact with the cryogenic coolant. It is particularly preferred if the coil is in direct contact with the liquefied cryogenic coolant at least in a partial region. In general, however, it should not be ruled out that the coil is in indirect contact with the coolant via an additional element. For example, the coil can be surrounded by an enveloping winding support, which can then advantageously be formed from a thermally comparatively highly conductive material, in order to allow heat dissipation toward the coolant.

According to an advantageous embodiment, the load can be a fuel cell system, in which the operating medium for providing electrical energy for the watercraft is converted. Such a fuel cell system is operated, in particular, with hydrogen as the first substance component of the operating medium and oxygen as the second substance component of the operating medium. Such a fuel cell system has proven to be an advantageous energy source for the electric driving of mobile systems since the operating media hydrogen and oxygen enable energy with a high energy density to be stored in a comparatively small space. By means of such a fuel cell, the electrical energy for operating the superconducting coil can be provided. Alternatively, however, the load can in principle also be an internal combustion engine or a turbine, in which the operating medium is converted to provide kinetic energy.

According to a first generally advantageous embodiment, the at least one superconducting coil can form a component part of an electric machine which is designed to drive the watercraft. In other words, the coil can thus be part of an electric motor and, in particular, part of an electric propulsion system of the watercraft. Such a superconducting electric drive is advantageous especially for more compact and, in particular, unmanned watercraft.

According to an advantageous variant of this first embodiment, the superconducting coil can be designed as part of a stator winding of the electric machine. Thus, the machine then comprises a superconducting stator which has at least one superconducting stator coil. In connection with the invention, this variant is particularly preferred since the superconducting coil is then arranged so as to be spatially fixed, at least in relation to the watercraft, and can thus be cooled more easily in a spatially fixed bath cryostat by a flow of liquid coolant around it.

However, according to an alternative variant of this first embodiment, the superconducting coil can be designed as part of a rotor winding of the electric machine. In this embodiment, not only the superconducting coil but also the cryostat tank surrounding the coil is expediently mounted so as to be rotatable about an axis of rotation in relation to the other parts of the watercraft. The implementation of rotating cryostat tanks for cooling superconducting rotor windings in electric machines is fundamentally known in the prior art. Likewise, the problems associated with the introduction and discharge of cryogenic coolant have already been fundamentally solved in the prior art, even for the connection of rotating and stationary systems.

According to a second generally advantageous embodiment, the at least one superconducting coil can be designed to generate a magnetic flux outside the watercraft. In particular, this may be a superconducting magnet coil which is designed for the magnetic triggering of a sea mine. As a particularly advantageous possibility, the first embodiment can be combined with the second embodiment, and therefore the same superconducting coil is, on the one hand, part of an electric propulsion system of the watercraft and, on the other hand, is used as a magnet coil for mine triggering. Such a combined function is made possible by sufficiently weak magnetic shielding of the drive motor. However, the coil can also be designed as a magnet coil separate from the drive of the watercraft.

In general, the watercraft can advantageously be designed as an unmanned watercraft. Such an embodiment as a drone is particularly advantageous because drones are often designed to be relatively small. In such a compact vehicle, the advantages of the invention are particularly effective in the context of the dual use of the cryogenic coolant and space-saving storage within the cryostat vessel. In particular, such an unmanned watercraft can advantageously be configured as a mine-clearing drone. In general, the superconducting coil can then be designed for the magnetic triggering of a sea mine.

According to an advantageous embodiment of the method, the load can be operated with gaseous cryogenic coolant, which evaporates during cooling of the at least one superconducting coil. Here too, the advantages are obtained in a manner similar to the advantages already described above for the corresponding embodiment of the watercraft.

### BRIEF DESCRIPTION OF THE DRAWINGS

The invention is described below by means of a number of preferred exemplary embodiments with reference to the appended drawings, in which:

FIG. 1 shows a schematic sectional illustration of a watercraft according to a first exemplary embodiment of the invention, and

FIGS. 2 to 4 show schematic sectional illustrations of various embodiments of superconducting coils and their associated cryostat tanks.

### DETAILED DESCRIPTION OF INVENTION

In the figures, identical or functionally identical elements are provided with the same reference signs.

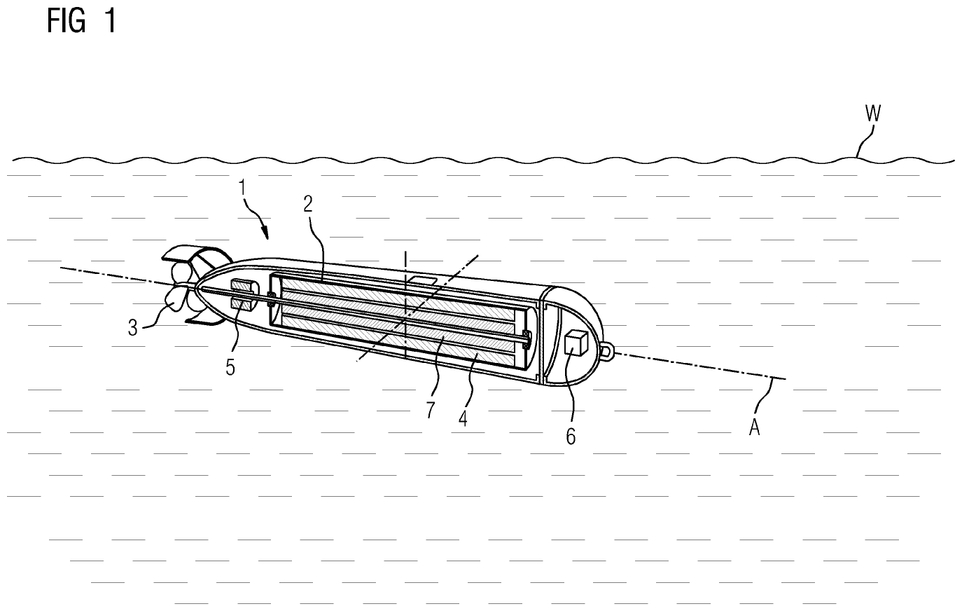

FIG. 1 shows a schematic partially perspective sectional illustration of a watercraft 1 according to a first example of the invention. In the example shown, this watercraft is a mine-clearing drone, which here just dips into the water W. Alternatively or additionally, however, use while floating on the surface of the water is also possible. The watercraft has a central longitudinal axis A and moves along a direction of travel which coincides with the longitudinal axis A, for example.

Here, the watercraft 1 is a self-propelled unmanned drone which can move in the water by means of an electric motor 2 and a propeller 3 mechanically coupled thereto and does not have to be towed by a mother ship. This drone is designed to generate a predetermined time-dependent magnetic profile at a specific target location in order to be able to detonate a magnetically triggerable sea mine. In order to generate the desired magnetic profile, the watercraft 1 is equipped with one or more superconducting magnet coils. Purely by way of example, several different superconducting magnet coils are shown for the watercraft 1: thus, the electric motor 2 has a stator winding 4 which can contain one or more superconducting coils. Moreover, the electric motor 2 has a rotor winding 7, which can likewise contain one or more superconducting coils. In addition, a single superconducting magnet coil 5 is shown in the rear part of the drone, said coil likewise cooperating in the generation of the desired magnetic profile but not being part of the electric motor. However, these windings or coils are illustrated only by way of example, and it is not necessary for all of them to be present at the same time in a watercraft. Thus, it is sufficient if at least one superconducting coil is present, this being embodied, for example, as part of the stator winding 4 or as part of the rotor winding 7 or else as a separate magnet coil 5. The other coils or windings can then optionally be configured alternatively as normally conducting coils.

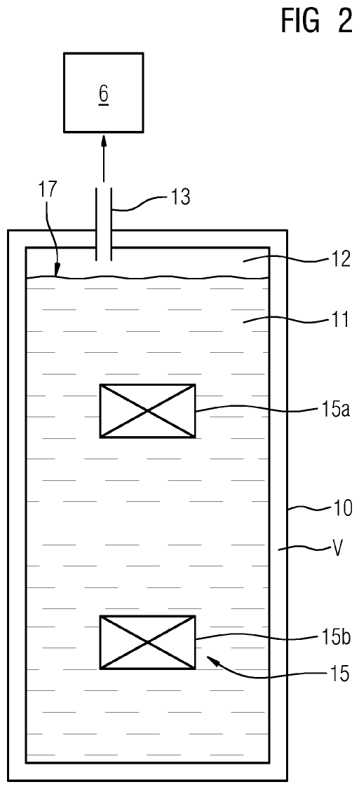

The watercraft 1 has a load 6 which is designed for converting an operating medium. In FIG. 1, purely by way of example, this load is arranged in the front region of the watercraft. For example, the load 6 may be a fuel cell which provides the electrical energy required for the electric motor 2. Such a fuel cell can, in particular, be operated with an operating medium which comprises hydrogen and oxygen. In this case, the hydrogen acts as fuel and forms a first substance component of the operating medium of the load 6. The oxygen acts as a combustion-promoting substance and forms a second substance component of the operating medium. If the watercraft is to be used under the surface of the water, it is generally expedient if both the first substance component and the second substance component are stored and carried along in the watercraft. The storage tanks and supply lines used for this purpose are, however, not shown in FIG. 1 for the sake of clarity. According to the invention, however, at least the first substance component of the operating medium is formed by a cryogenic coolant which is used for cooling the superconducting coil to a cryogenic operating temperature. This dual use of the first substance component is explained in more detail in conjunction with FIGS. 2 to 4.

Thus, FIG. 2 shows a schematic sectional illustration of a superconducting coil 15 in its associated cryostat tank 10. This coil 15 can be used in a watercraft according to one example of the present invention, for example in a watercraft which is configured in a manner similar to that in FIG. 1. In principle, the coil may, in particular, be a coil of a rotor winding 7 or a coil of a stator winding 4 or a separate magnet coil 5. It should be assumed below, for example, that the coil 15 is a fixed coil in relation to the rest of the watercraft—that is to say a stator coil or a separate magnet coil 5.

The superconducting coil 15 is arranged within a first cryostat tank 10 and is surrounded by the latter. A liquid cryogenic coolant 11 is arranged in the interior of this first cryostat tank 10 and flows around the superconducting coil 15 and thus cools it to a cryogenic operating temperature. For example, the liquid cryogenic coolant is liquid hydrogen. During the cooling of the coil 15, this liquid hydrogen partially evaporates, with the result that a region containing gaseous coolant 12 is formed geodetically above a coolant level 17. This gaseous coolant 12 can escape from the first cryostat tank 10 through a gas outlet line 13 and can be fed via this line 13 to the load 6, which is shown here only schematically. Thus, in this way, the hydrogen required by a fuel cell, for example, is fed to it. In the example shown, this hydrogen is stored substantially within the first cryostat tank 10. Apart from the comparatively small volume of the line 13, there is, in particular, no additional storage reservoir for the hydrogen. This ensures that the space required within the cryostat tank for the liquid coolant can also be used at the same time for storing the operating medium of the load 6. This eliminates the space for an additional storage tank, at least for the first substance component of the operating medium. To refill the cryostat tank 10, the liquid coolant 11 can be introduced either through the line 13 or through a further line and/or opening (not illustrated specifically here).

In the example shown, the cryostat tank 10 is of double-walled design, with a vacuum space V being formed between the two walls. This serves to thermally insulate the interior of the cryostat from the comparatively warm external environment. Alternatively or additionally, however, the cryostat tank can also be thermally insulated by other measures, for example by means of perlite and/or superinsulation. In general, the cryostat tank can be of annular configuration (that is to say topologically biconnected), with the result that it surrounds an annular coil having two coil legs in a comparatively compact arrangement, the center of the coil then being free of coolant. Alternatively, however, the cryostat tank can also be configured as a simple pot (that is to say it can be topologically simply connected), with the result that the region in the interior of an annular coil can also be filled by the liquid cryogenic coolant. This simpler embodiment is shown in the sectional illustration of FIG. 2. In this case, the two superimposed coil elements 15a and 15b may be, for example, two opposite legs of the same coil 15. Alternatively, however, it would also be possible for the two elements 15a and 15b shown to be separate coils lying one above the other and for FIG. 2 to represent only a section of an annular cryostat tank 10.

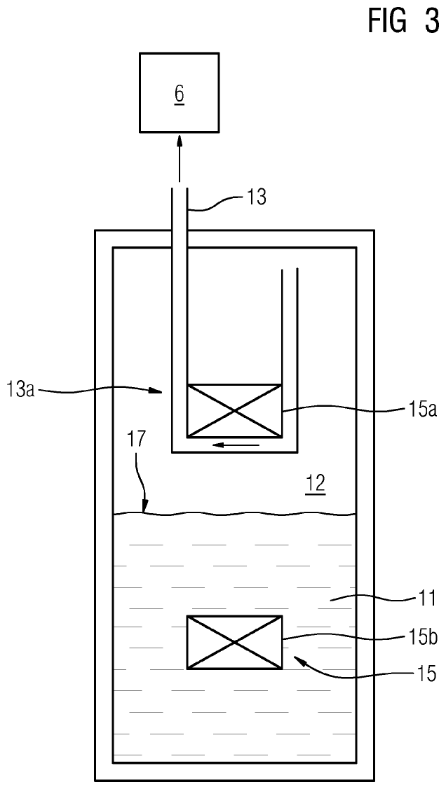

If the quantity of cryogenic coolant required for the operation of the load 6 is stored substantially within the first cryostat tank 10 and is thus not refilled from an external storage tank, the coolant level 17 gradually drops during the operation of the watercraft 1. This is caused by the fact that the liquid coolant 11 is gradually evaporated and the gaseous coolant 12 which is formed is fed to the load 6. Correspondingly, FIG. 3 shows an operating state in which a significant portion of the liquid coolant 11 has already been consumed. Therefore, the coolant level 17 is already below half of the upper coil leg 15a, and therefore there is already no longer a flow of liquid coolant 11 around at least this coil leg 15a. In order nevertheless to achieve reliable cooling of the entire coil 15 to the cryogenic operating temperature, different measures can be taken. Thus, on the one hand, the coil 15 itself can be designed to be highly thermally conductive, thus ensuring that a flow of liquid coolant 11 around the lower coil leg 15b is sufficient to cool the upper coil leg 15a to a sufficiently low temperature by heat conduction. This can be achieved, for example, by a highly thermally conductive metallic substrate of a superconducting strip conductor on which the coil winding is based. Alternatively or additionally, however, the individual partial regions 15a and 15b can also be connected to one another in a heat-conducting manner by one or more additional bridging elements. For example, such an additional element can be provided by a heat-conducting coil carrier (not shown here).

As an alternative or additional measure for improved cooling of the upper coil part 15a, however, it is also possible for the gas outlet line 13 to be configured in such a way that efficient cooling of the coil part 15a is made possible by the gas flowing in said line. Such an optional configuration is shown by way of example in FIG. 3: here, the gas outlet line 13 is extended into the interior of the cryostat 10 and shaped in such a way that it is thermally coupled to the upper coil leg 15a at least in a partial region. This ensures that the gas flowing in the line 13 can cool this part 15a of the coil more efficiently than would be the case without such coupling. In particular, as a result of this particular embodiment, it is especially the outflowing gas which selectively absorbs the heat from the upper coil leg 15a, and excessive heating of the remaining gaseous coolant 12, which is above the coolant level 17 but is not yet being taken from the gas space, is advantageously reduced.

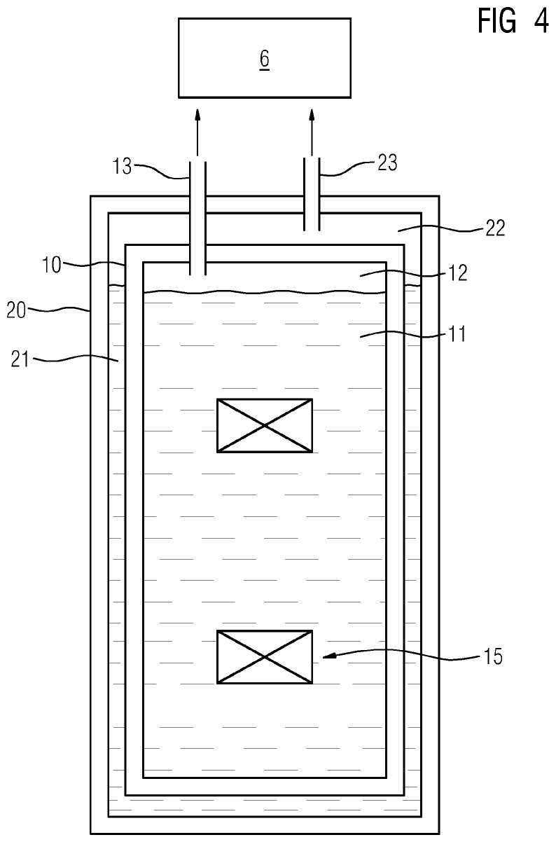

FIG. 4 shows a schematic sectional illustration of a coil 15 according to a further exemplary embodiment of the invention. The coil is arranged in a first cryostat tank 10 in a manner similar to the example of FIG. 2 and is cooled there by a liquid cryogenic coolant 11, which is converted in part by evaporation into gaseous coolant 12. In addition, the first cryostat tank 10 is here also surrounded by a second cryostat tank 20, which likewise contains a liquid coolant 21. These two cryostat tanks 10 and 20 are nested in one another in such a way that, overall, an onion-skin-like arrangement consisting of a plurality of enveloping jackets is obtained: the inner liquid coolant 11 flows around the coil 15. This coolant is enclosed by the double-walled first cryostat tank 10. The outer liquid coolant 21 flows around this inner cryostat tank. This outer coolant is enclosed by the double-walled cryostat tank 20. Overall, this onion-skin-like structure results in particularly effective thermal insulation of the internal superconducting coil 15.

As a particularly advantageous option, the selected liquid coolant 11 in the first cryostat tank 10 and the selected liquid coolant 21 in the second cryostat tank 20 can be different. In particular, the inner coolant 11 can be liquid hydrogen and the outer coolant 21 can be liquid oxygen. Or, in more general terms, the inner coolant can be a first substance component of the operating medium and the outer coolant can be a second substance component of the operating medium of the load 6. Accordingly, in the example of FIG. 4, these two coolants are fed in parallel to the load 6 after their evaporation through respectively associated gas outlet lines 13 and 23. It is thus possible, in particular, to implement the supply of hydrogen and oxygen to a fuel cell in a particularly simple and space-saving manner.

### LIST OF REFERENCE SIGNS

1 watercraft
2 electric motor
3 propeller
4 stator winding
5 magnet coil
6 load
7 rotor winding
10 first cryostat tank
11 liquid coolant
12 gaseous coolant
13 gas outlet line
13a partial region
15 superconducting coil
15a upper coil leg
15b lower coil leg
17 coolant level
20 second cryostat tank
21 liquid second substance component
22 gaseous second substance component
23 second gas outlet line
A central axis
V vacuum space
W water

1. A watercraft having comprising:
at least one high-temperature superconducting coil, and
a cooling system for cooling the high-temperature superconducting coil to a cryogenic operating temperature,
wherein the cooling system has a first cryostat tank, which surrounds the high-temperature superconducting coil and is designed to hold a liquid phase of a cryogenic coolant,
wherein the watercraft also has a load, which is designed to convert an operating medium in the form of a fuel and/or in the form of a combustion-promoting substance,
wherein at least one first substance component of the operating medium is formed by the cryogenic coolant, and
wherein the first cryostat tank is designed to hold a majority of the total quantity of the first substance component of the operating medium required for the operation of the load.

2. The watercraft as claimed in claim 1,
wherein the first cryostat tank is designed to hold a proportion of at least 75%, of the total quantity of the first substance component of the operating medium required for operation of the load.

3. The watercraft as claimed in claim 1,
wherein the cryogenic coolant is or comprises hydrogen, methane, natural gas or oxygen.

4. The watercraft as claimed in claim 1,
wherein the operating medium has a fuel as the first substance component and a combustion-promoting substance as a second substance component,
wherein the first cryostat tank is designed to hold the first substance component, and
wherein the cooling system has a second cryostat tank, which encloses the first cryostat tank in the form of a jacket and is designed to hold the second substance component.

5. The watercraft as claimed in claim 1,
wherein the load is designed to be operated with a gaseous phase of the cryogenic coolant.

6. The watercraft as claimed in claim 5,
which comprises, as part of the cooling system, a gas outlet line, which is arranged at least partially within the first cryostat tank and is thermally coupled there, at least in a partial region, to a part of the superconducting coil in such a way that cooling of the superconducting coil is effected by the gaseous phase of the cryogenic coolant flowing in the gas outlet line.

7. The watercraft as claimed in claim 1,
wherein the load is a fuel cell system.

8. The watercraft as claimed in claim 1,
wherein the at least one high-temperature superconducting coil forms a component part of an electric machine which is designed to drive the watercraft.

9. The watercraft as claimed in claim 8,
wherein the superconducting coil is designed as part of a stator winding of the electric machine.

10. The watercraft as claimed in claim 8,
wherein the superconducting coil is designed as part of a rotor winding of the electric machine.

11. The watercraft as claimed in claim 1,
wherein in which the at least one superconducting coil is designed to generate a magnetic flux outside the watercraft.

12. The watercraft as claimed in claim 1,
wherein the watercraft is designed as an unmanned watercraft.

13. The watercraft as claimed in claim 12,
wherein the watercraft is designed as a mine-clearing drone.

14. A method for operating a watercraft as claimed claim 1, comprising:
cooling the at least one high-temperature superconducting coil via the liquid phase of the cryogenic coolant in the first cryostat tank, and
using the same cryogenic coolant as the substance component of the operating medium which is converted by means of the load.

15. The method as claimed in claim 14, further comprising:
operating the load with gaseous cryogenic coolant, which evaporates during cooling of the at least one superconducting coil.

16. The watercraft as claimed in claim 2,
wherein the first cryostat tank is designed to hold a proportion of at least 90% of the total quantity of the first substance component of the operating medium required for the operation of the load.
